(19) United States
(12) Patent Application Publication
(10) Pub. No.: US 2016/0205001 A1
(43) Pub. Date: Jul. 14, 2016

(54) SYSTEM AND PROTOCOL FOR NETWORK ASSESSMENT

(71) Applicant: Michael Cotrone, Browns Summit, NC (US)

(72) Inventor: Michael Cotrone, Browns Summit, NC (US)

(21) Appl. No.: 14/596,834

(22) Filed: Jan. 14, 2015

(51) Int. Cl. H04L 12/26

(52) U.S. Cl. CPC H04L 43/06; H04L 43/50; H04L 43/08

(57) ABSTRACT

A protocol for assessing one or more network devices in a communication network is provided. The method includes establishing a communication session with a source network device, negotiating a payload format for exchange of information with the source network device, receiving instructions from the source network device identifying a set of parameters to be assessed and a set of network devices to be assessed, assessing the set of parameters corresponding to the set of network devices, and reporting the output of assessment to the source network device as per the negotiated format.

### FIELD OF INVENTION

The present invention relates to a system and method for performing network assessment. More specifically, the present invention is related to a system and a protocol for assessment of network devices in communication networks where the network devices may be using different network management software.

### BACKGROUND

Regular assessment of communication networks is essential to maintain optimal performance of devices in the communication network. In implementations of such networks, integrity and performance of different devices on the network is critical and hence there is a need for managing, monitoring and analyzing the network. To facilitate such network management, a suite of management protocols have been developed in prior art that assist in monitoring of networked devices, i.e., devices in a communication network.

For example, in prior art, when the networked devices are running one or more different network management software, then the network administrator is provided with various tools by the vendors or manufacturers of the different network management software. These tools enable the network administrator to interact, view, edit, update, alter, and manage information communicated by the networked devices over the network.

These tools are typically vendor specific, e.g., specific to particular network management software, and each may have a different interface and utilize different command structures, which in turn may provide and present data and other information to the network administrator in different formats. The network administrator may therefore need to learn and understand the varying formats used by the multiple tools.

In summary, the existing analysis and management tools provide adequate review and analysis when all the network devices follow the same network management software. However, it is left to the network administrator to select combination of specific tools needed, implement these tools and combine results obtained by such tools to properly manage a network containing devices running different network management software. There is a need in the industry to provide network administrators with a single analysis unit for managing network problems, measurement of network performance, and monitoring network status.

In view of one or more limitations of the present solutions described above, there is a need for improvement in the area of network assessment, more specifically, there is need for a network assessment protocol to ensure a better quality of service to the users of network devices that use different network management software over a network.

### SUMMARY OF INVENTION

In one embodiment, the invention provides a method for assessing one or more network devices in a communication network. The method includes establishing a communication session with a source network device of the one or more network devices and negotiating a payload format for exchange of information with the source network device. Thereafter, the method includes receiving, from the source network device, a first instruction identifying a set of parameters to be assessed and a second instruction identifying a set of network devices to be assessed, in accordance with the negotiated payload format. Thereafter, the method includes assessing the set of parameters corresponding to the set of network devices, and reporting an output of the assessment to the source network device in accordance with the negotiated format.

In some exemplary aspects of this embodiment, the method also includes authenticating the source network device.

In some exemplary aspects of this embodiment, the method also includes receiving instructions to initiate the assessment.

In some exemplary aspects of this embodiment, the method also includes reporting interim results of the assessment prior to completion of the assessment.

In some exemplary aspects of this embodiment, the method also includes sending, to the source network device, information associated with termination of the session upon re-establishment of the session.

In some exemplary aspects of this embodiment, the method also includes continuing the assessing upon termination of the session.

Some examples of the network devices in this embodiment may include, but are not limited to, a router, a gateway, a switch, a hub, a network bus, a modem, a cable and a computer.

Some examples of the parameters to be assessed in this embodiment may include, but are not limited to, IP address, MAC address, load information, bandwidth, security data, log table, topology, credentials, routing table, reachability status and trace-route information.

In another embodiment as well, the invention provides a method for assessing one or more network devices in a communication network. The method includes establishing a communication session with a destination network device of the one or more network devices and negotiating a payload format for exchange of information with the destination network device. Thereafter, the method includes sending to the destination network device, a first instruction identifying a set of parameters to be assessed and a second instruction identifying a set of network devices to be assessed, in accordance with the negotiated payload format. Thereafter the method includes receiving an output of the assessment from the destination network device in accordance with said negotiated format.

In some exemplary aspects of this embodiment, the method also includes authenticating the destination network device.

In some exemplary aspects of the embodiment, the method also includes sending instructions to the destination network device to initiate assessing of the set of network devices.

In yet another embodiment, the present invention provides a device for assessing one or more network devices in a communication network. The device includes a transceiver capable of exchanging information with the one or more network devices, a processor coupled to the transceiver, and a non-transitory computer-readable storage medium coupled to the processor and the transceiver. The processor executes one or more modules stored on the storage medium. The one or more modules include a session module configured to manage a communication session with a source network device of the one or more network devices, a format negotiation module configured to negotiate a payload format with the source network device, an instruction module configured to interpret instructions received by the transceiver from the source network device, an assessment module configured to assess a set of parameters associated with a set of network devices, and a reporting module configured to generate an output of the assessment in accordance with the payload format and to invoke the transceiver to transmit the output to the source network device. The instructions received by the transceiver and interpreted by the instruction module include a first instruction identifying the set of parameters to be assessed and a second instruction identifying the set of network devices to be assessed.

In some aspects of this embodiment, the non-transitory computer-readable storage medium also includes an authentication module to authenticate the source network device.

In some aspects of this embodiment, the instruction module is further configured to interpret instructions to initiate the assessment.

In some aspects of this embodiment, the reporting module is further configured to generate interim results of the assessment prior to completion of the assessment.

In some aspects of this embodiment, the reporting module is further configured to generate information associated with termination of the session upon re-establishment of the session.

In some aspects of this embodiment, the assessment module is further configured continue the assessment upon termination of the session.

In yet another embodiment as well, the present invention provides a device for assessing one or more network devices in a communication network. The device includes a transceiver capable of exchanging information with the one or more network devices, a processor coupled to the transceiver, and a non-transitory computer-readable storage medium coupled to the processor and the transceiver, such that the processor executes one or more modules stored on the storage medium. The one or more modules on the storage medium include a session module configured to manage a communication session with a destination network device of the one or more network devices, a format negotiation module configured to negotiate a payload format with the destination network device, and an instruction module configured to generate instructions for transmission by the transceiver to the destination network device. The instructions include either of a first instruction identifying a set of parameters to be assessed and a second instruction identifying a set of network devices to be assessed.

These and other features, aspects and advantages of the present invention will become better understood with reference to the following drawings, description and claims.

### BRIEF DESCRIPTION OF DRAWINGS

The features of the present invention, which are believed to be novel, are set forth with particularity in the appended claims. The invention may be best understood by reference to the following description, taken in conjunction with the accompanying figures. These figures and the associated description are provided to illustrate some embodiments of the invention, and not to limit the scope of the invention. In the following the invention will be described in greater detail with reference to exemplary embodiments in accordance with the accompanying drawings, in which:

FIG. 1 illustrates an exemplary environment in which several embodiments of the present invention can be practiced;

FIG. 2 is a block diagram illustrating a device, more specifically, a destination network device for facilitating network assessment, in accordance with an exemplary embodiment of the present invention;

FIG. 3 is also a block diagram illustrating a device, more specifically, a source network device for facilitating network assessment, in accordance with yet another exemplary embodiment of the present invention;

FIG. 4 is a flow chart demonstrating a method, specifically, a method performed at the destination network device, for facilitating network assessment, in accordance with yet another exemplary embodiment of the present invention; and

FIG. 5 is also a flow chart demonstrating a method, specifically, a method performed at the source network device, for facilitating network assessment, in accordance with yet another exemplary embodiment of the present invention.

Skilled artisans will appreciate that elements in figures are illustrated for simplicity and clarity and have not necessarily been drawn to scale. For example, the dimensions of some of the elements in the figures may be exaggerated, relative to other elements, to help improving an understanding of the embodiments of the present invention.

There may be additional structures described in the foregoing application that are not depicted on one of the described drawings. In the event such a structure is described, but not depicted in a drawing, the absence of such a drawing should not be considered as an omission of such design from the specification.

### DETAILED DESCRIPTION OF INVENTION

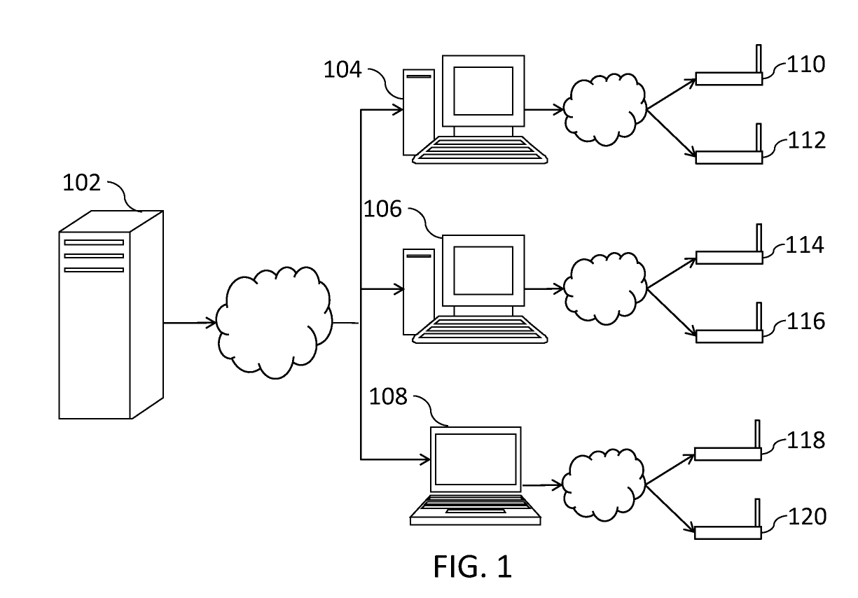

The following detailed description is merely exemplary in nature and is to enable any person skilled in the art to make and use the invention. The examples shown in description are not intended to limit the application and uses of the various embodiments. Various modifications to the disclosed invention will be readily apparent to those skilled in the art, and the methodology defined herein may be applied to other embodiments and applications without departing from the spirit and the scope of the present disclosure. Thus, the present invention is not limited to the examples discussed below, but is to be accorded the widest scope consistent with the methodology and features disclosed herein. It should also be noted that FIGS. 1 to 5 are merely illustrative and may not be drawn to scale.

The foregoing objects of the present invention are accomplished and the problems and shortcomings associated with the prior art, techniques and approaches are overcome by the present invention, as described below in the preferred embodiments.

The exemplary methods described below are typically stored on a computer-readable storage medium, which may be any device that can store code for use by a computer system, mobile and others. The computer-readable storage medium includes, but is not limited to volatile memory, non-volatile memory, magnetic and optical storage devices such as disk drives, magnetic tape, CDs (compact discs), DVDs (digital versatile discs or digital video discs), or other media capable of storing code now known or later developed.

Furthermore, methods described herein can be embossed on hardware modules or apparatus. These modules or device may include, but are not limited to, an application-specific integrated circuit (ASIC) chip, a field-programmable gate array (FPGA), a dedicated or shared processor that executes a particular software module or a piece of code at a particular time, and/or other programmable-logic devices known or later developed. When the hardware modules or apparatus are activated, they perform the methods and processes included within them.

The terms “a” or “an”, as used herein, are defined as one or more than one. The term “another”, as used herein, is defined as at least a second or more. The terms “including” and/or “having” as used herein, are defined as comprising (i.e. open transition).

As depicted in FIG. 1, embodiments of present invention can be practiced in a communication network 100. The communication network includes one or more network devices, for example, network devices 102, 104, 106, 108, 110, 112, 114, 116, 118 and 120. Examples of such communication network include, but, are not limited to, a Wide Area Network (WAN), Internet, heterogeneous networks with several subsets of them located at multiple location and using different network management software, etc.

Examples of such network devices 102 to 120 include, but are not limited to, different subsets of network devices, each subset enabling one or more functionalities within the communication network 100. For example, the network devices 102 to 120 may each be one or more of a router to route packets or other data units across the communication network 100, a wireless access point to provide client devices with wireless access to the communication network 100, a Dynamic Host Configuration Protocol (DHCP) server to provide various parameters necessary for other devices, such as endpoint user devices, to operate in an Internet Protocol (IP) network, a Domain Name System (DNS) server to provide domain names, a Digital Subscriber Line Access Multiplexer (DSLAM) to facilitate high-speed access to a network via a telephone line, a border gateway controller to control the interconnection of networks or sub-networks, a general gateway that controls access between networks, an application layer gateway that controls access to a network or sub-network based on application layer data, as well as, any other device commonly found in a network, such as the communication network 100.

Further, although not explicitly shown in the FIG. 1, the network devices 102 to 120 may interconnect with one another via communicative links to form a communication network, as well as, one or more sub-networks comprised of subsets of the network devices 102 to 120. The invention therefore should not be limited strictly to the communication network 100 as shown in FIG. 1.

In the present invention, network assessment is achieved by interaction between a source network device out of the one or more network devices and a destination network device out of the one or more network devices, which then performs the network assessment of the one or more network devices. Any of the network devices 102 to 120 can be a source network device or a destination network device. For the purpose of this exemplary illustration, the network device 102, which is depicted as a server computer, is the source network device 102. Although in the FIG. 1 the source network device is shown as a server, it will be readily apparent to a person having ordinary skill in the art that different embodiments of the invention can be practiced with the source network device being any other type of network device.

Similarly, for the purpose of this exemplary illustration, network devices 104, 106 and 108, which are depicted as computers, are the destination network devices 104, 106 and 108. Although in the FIG. 1 the destination network device is shown as a computer, it will be readily apparent to a person having ordinary skill in the art that different embodiments of the invention can be practiced with the destination network device being any other type of network device.

Similarly, for the purpose of this exemplary illustration, network devices 110 to 120 are shown as routers. It will, however, be readily apparent to a person having ordinary skill in the art that different embodiments of the invention can be practiced with the network devices 110 to 120 being any other type of network device.

Further, the destination network devices 104, 106 and 108 may run same or different network management software. For the purpose of this illustration, the destination network devices 104, 106 and 108 can be considered to run different network management software. The network devices 110 and 112 shown to be connected to the destination network device 104 can be considered to run the same network management software as the destination network device 104. Similarly, the network devices 114 and 116 shown to be connected to the destination network device 106 can be considered to run the same network management software as the destination network device 106. Further, the network devices 118 and 120 shown to be connected to the destination network device 108 can be considered to run the same network management software as the destination network device 108.

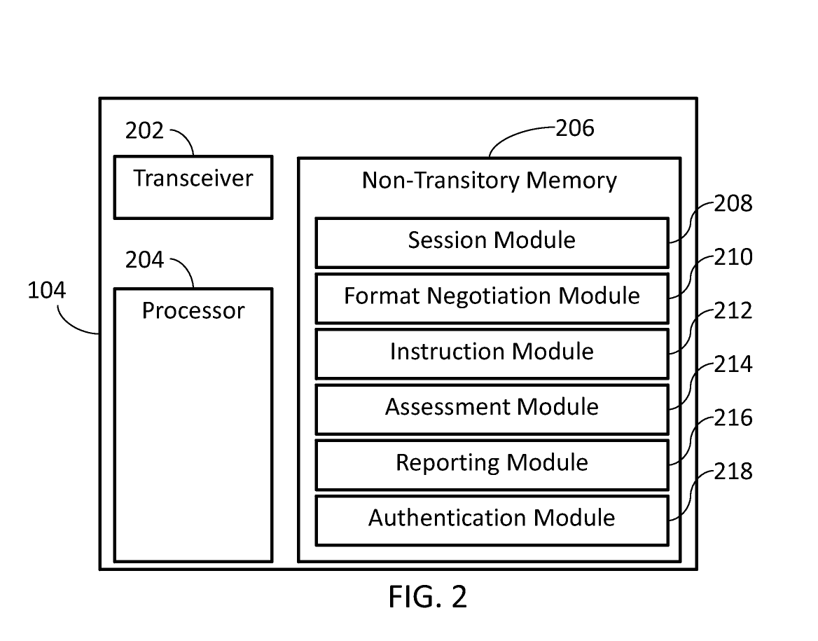

Referring now to FIG. 2, which is a block diagram of the destination network device 104 for assessing the one or more network devices 102, 104, 106, 108, 110, 112, 114, 116, 118 and 120 of the communication network 100. The destination network device 104, assesses the network devices 102, 104, 106, 108, 110, 112, 114, 116, 118 and 120 in the communication network 100 in conjunction with the source network device 102.

The destination network device 104 is shown to include a transceiver 202, a processor 204 and a non-transitory memory storage medium 206.

The transceiver 202 is capable of exchanging information with the network devices 102 to 120 in the communication network 100. For example, the transceiver 202 can receive instructions from the source network device 102. The transceiver 202 can also receive information and/or messages from other devices in the communication network 100, for example, it can receive information corresponding to various parameters of performance from the network devices 110 and 112. Further, the transceiver 202 can also transmit information to the source network device 102. The transceiver 202 can also transmit information to the network devices 110 and 112.

The processor 204 is coupled to the transceiver 202 and the non-transitory computer-readable storage medium 206.

The non-transitory computer-readable storage medium 206 (hereinafter referred to as storage medium 206) includes one or more modules 208 to 218, and the processor 204 is configured to execute these one or more modules 208 to 218. The modules 208 to 218 include a session module 208 configured to manage a communication session with the source network device 102. The session module 208 can initiate the communication session by itself or it can respond to a request for initiation of the communication session obtained from the source network device 102. The session module 208 also ensures that the session is re-established if the session gets terminated without any instructions for termination of the session from the destination network device 104 or the source network device 102.

Another module in the storage medium 206 is a format negotiation module 210. The format negotiation module 210 negotiates the payload format with the source network device 102. After the communication session between the source network device 102 and the destination network device 104 is established, the format negotiation module 210 of the destination network device 104 negotiates with the source network device 102 the format in which subsequent messages will be exchanged between the destination network device 104 and the source network device 102.

Another module in the storage medium 206 is an instruction module 212. The instruction module 212 interprets the instructions received by the transceiver 202 from the source network device 102. Such instructions may include a first instruction identifying a set of parameters to be assessed by the destination network device 104. Such instructions may also include a second instruction identifying a set of network devices to be assessed, for example, the second instruction may identify that the network devices 110 and 112 are to be assessed by the destination network device 104. In an exemplary embodiment of the present invention, the instruction module 212 is also configured to interpret instructions to initiate the assessment.

Another module in the storage medium 206 is an assessment module 214. The assessment module 214 is configured to assess the set of parameters associated with the set of network devices, for example, the network devices 110 and 112. In an exemplary embodiment, the assessment module 214 is configured to continue the assessment of the network devices 110 and 112 even upon termination of the session between the source network device 102 and the destination network device 104.

Another module in the storage medium 206 is a reporting module 216 configured to generate an output of the assessment of the set of network devices in accordance with the payload format. The reporting module 216 is also configured to invoke the transceiver to transmit the output of the assessment, among other pieces of information, to the source network device 102. In an exemplary embodiment, the reporting module 216 is also configured to generate interim results of the assessment prior to completion of the assessment. In another exemplary embodiment, the reporting module 216 is also configured to generate information associated with termination of the session upon re-establishment of the session.

In an exemplary embodiment, the storage medium 206 also includes an authentication module 218 to authenticate said source network device 102.

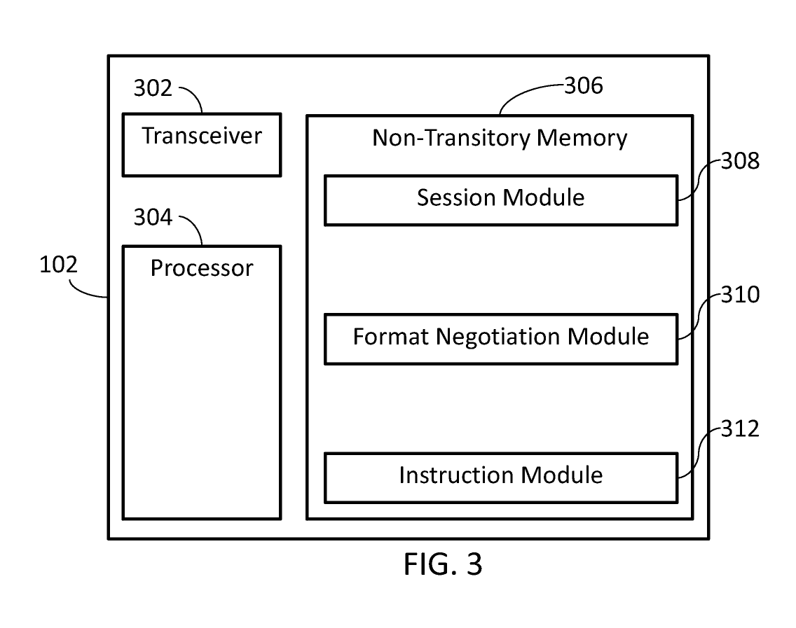

Referring now to FIG. 3, which is a block diagram of the source network device 102 for assessing the one or more network devices 102, 104, 106, 108, 110, 112, 114, 116, 118 and 120 of the communication network 100. The source network device 102, assesses the network devices 102, 104, 106, 108, 110, 112, 114, 116, 118 and 120 in the communication network 100 in conjunction with the destination network devices 104, 106 and 108.

The source network device 102 is shown to include a transceiver 302, a processor 304 and a non-transitory memory storage medium 306.

The transceiver 302 is capable of exchanging information with the network devices 102 to 120 in the communication network 100.

The processor 304 is coupled to the transceiver 302 and the non-transitory computer-readable storage medium 306.

The non-transitory computer-readable storage medium 306 (hereinafter referred to as storage medium 306) includes one or more modules 308 to 312, and the processor 304 is configured to execute these one or more modules 308 to 312. The modules 308 to 312 include a session module 308 configured to manage a communication session with the destination network device 104.

Another module in the storage medium 306 include a format negotiation module 310 configured to negotiate a payload format with the destination network device 104.

Another module in the storage medium 306 is an instruction module 312. The instruction module is configured to generate instructions for transmission by the transceiver 302 to the destination network device 104. These instructions include a first instruction identifying a set of parameters to be assessed and/or a second instruction identifying a set of network devices to be assessed.

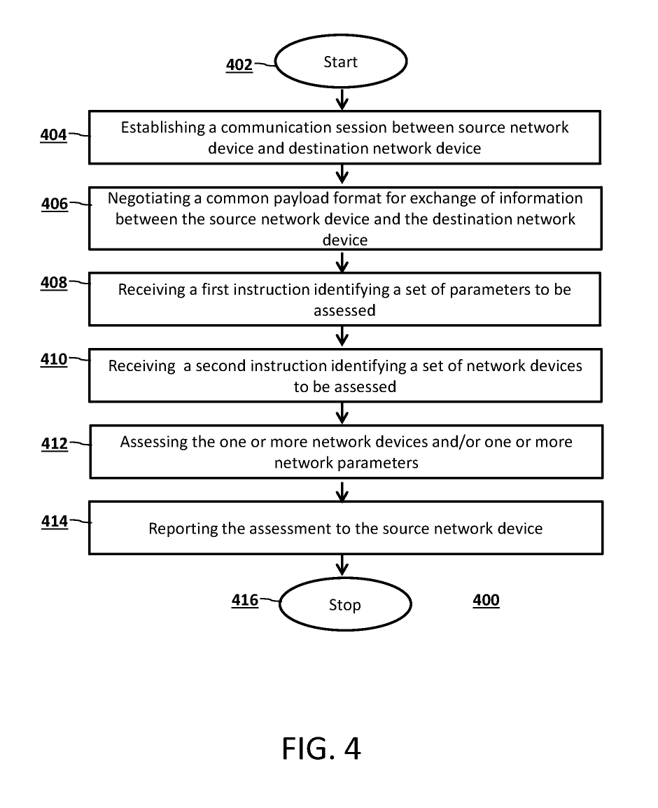

FIG. 4 illustrates a method 400, in accordance with an embodiment of the present invention, for performing assessment of one or more network devices, for example, the network devices 102 to 120, in a communication network, for example, the communication network 100.

To describe the method 400, reference will be made to FIGS. 1, 2 and 3 although it is understood that the method 400 can be implemented in any other suitable environment. Moreover, the invention is not limited to the order in which the steps are listed in the method 400. Further, it will also be apparent to those skilled in the art that the method 400 may include one or more additional steps for further enhancement of the effectiveness of the method 400, however, are not essential to the method 400, in accordance with the present invention.

The method 400 is initiated at step 402. The method 400 is being performed at one of the destination network devices out of the one or more network devices. For example, the method 400 can be performed at the destination network device 104.

At step 404, a communication session is established with a source network device, for example, the source network device 102. The communication session is established by the session module 202 of the destination network device 104 and the session module 302 of the source network device 102.

In an alternate embodiment, the method 400 may also include a step of authenticating the source network device 102 by the destination network device 104 prior to OR as a part of establishing the communication session. For example, such authentication is performed by the authentication module 218 of the destination network device 104.

Thereafter, at step 406, the source network device 102 and the destination network device 104 negotiate a payload format for exchange of information, from one or more formats for exchange of information. The payload format is negotiated between the format negotiation module 204 of the destination network device 104 and the format negotiation module 304 of the source network device 102. The negotiated format may include a specific structure that helps exchange of data and other information in a unified format between the destination network device 104 and the source network device 102. In one exemplary embodiment, the destination network device 104 runs a software ‘A’, and uses a corresponding structure 13′ to exchange information with other network devices which also run the software ‘A’. In an exemplary implementation of this exemplary embodiment, the destination network device 104 can negotiate the structure 13′ to be the payload format. In another exemplary implementation of this exemplary embodiment, the negotiated format may be a different format which is more convenient to the source network device 102.

At step 408, the destination network device 104 receives the first instruction from the source network device 102, in which the set of parameters to be assessed by the destination network device 104 are identified. The first instruction is in the common negotiated format between the source network device 102 and the destination network device 104 at step 406. For example, at the step 408 the destination network device 104 can receive instructions from the source network device 102 to monitor the load and powered-on status.

Subsequently, at step 410, the destination network device 104 receives a second instruction from the source network device 102, in which the set of network devices to be assessed by the destination network device 104 are identified. The second instruction is also in the common negotiated format. For example, at step 410 the destination network device 104 may receive instructions to assess the network devices 110 and 112.

The receipt and interpretation of instructions is enabled by the instruction module 312 of the source network device 102 and the instruction module 212 of the destination network device 104.

At step 412, the destination network device 104 assesses the set of parameters corresponding to the set of network devices. For example, the destination network device 104 assesses the load and the powered-on status corresponding to the network devices 110 and 112. The assessment is conducted by the assessment module 214 of the destination network device 104.

In an embodiment, the destination network device 104 receives instructions from the source network device 102 to initiate the assessment, and the destination network device 104 does not initiate the assessment without receiving such instructions. In another embodiment, the destination network device 104 initiates the assessment without receiving such instructions from the source network device 102.

Thereafter, at step 414, the destination network device 104 reports the output of the assessment to the source network device 102. The output of the assessment is reported in the common negotiated format between the source network device 102 and the destination network device 104 at step 406. The output of the assessment is generated by the reporting module 216 of the destination network device 104. Further, the reporting module 216 also invokes the transceiver 202 to transmit/report the output of the assessment to the source network device 102.

In an embodiment, the destination network device 104 can also report interim results of the assessment to the source network device 102. For example, such interim results may include, but are not limited to, percentage completion of the assessment, time left to complete the assessment, inability to complete the assessment, average load on the network device for a pre-defined duration.

In an event the communication session between the source network device 102 and the network device 104 may get terminated. In accordance with an exemplary embodiment of the present invention, on instance of such an event, the destination network device 104 continues to assess the set of network devices 106 and 108. The assessment module 214 is optionally configured to enable such continued assessment.

When the terminated communication session is re-established, the destination network device 104 sends the information about such termination to the source network device 102. This information may include, but is not limited to, an update on the progress of the assessment, output of the assessment and reason for such termination.

The method 400 is terminated at step 416.

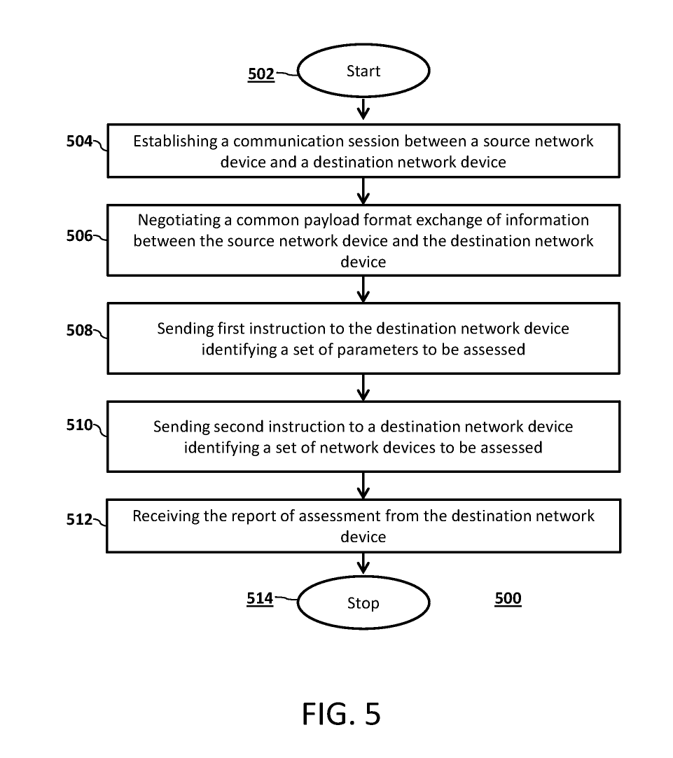

FIG. 5 illustrates a method 500, in accordance with an embodiment of the present invention, for performing assessment of one or more network devices in a communication network.

To describe the method 500, reference will be made to FIGS. 1, 2 and 3 although it is understood that the method 500 can be implemented in any other suitable environment. Moreover, the invention is not limited to the order in which the steps are listed in the method 500. Further, it will also be apparent to those skilled in the art that the method 500 may include one or more additional steps for further enhancement of the effectiveness of the method 500, however, are not essential to the method 500, in accordance with the present invention.

The method 500 is initiated at step 502. The method 500 is being performed at the source network device, for example, the method 500 can be performed on the source network device 102.

At step 504, a communication session is established with a destination network device, for example, the destination network device 104. The communication session is established by the session module 202 of the destination network device 104 and the session module 302 of the source network device 102.

In an alternate embodiment, the method 500 may also include a step of having the source network device 102 authenticated by the destination network device 104 prior to OR as a part of establishing the communication session. For example, such authentication is performed by the authentication module 218 of the destination network device 104.

Thereafter, at step 506, the source network device 102 and the destination network device 104 negotiate a payload format for exchange of information, from one or more formats for exchange of information. The payload format is negotiated between the format negotiation module 204 of the destination network device 104 and the format negotiation module 304 of the source network device 102. The negotiated format may include a specific structure that helps exchange of data and other information in a unified format to a network administrator.

At step 508, the source network device 102 sends the first instruction to the destination network device 104, in which the set of parameters to be assessed by the destination network device 104 are identified. The first instruction is in the common negotiated format between the source network device 102 and the destination network device 104 at step 506. For example, at the step 508 the source network device 102 can send instructions to the destination network device 104 to monitor the load and powered-on status.

Subsequently, at step 510, the source network device 102 sends a second instruction from to the destination network device 104, in which the set of network devices to be assessed by the destination network device 104 are identified. The second instruction is also in the common negotiated format. For example, at step 510 the source network device 102 can send instructions to the destination network device 104 to assess the network devices 110 and 112.

Thereafter, at step 512, output of the assessment is reported to the source network device 102 by the destination network device 104. The output of the assessment is reported in the common negotiated format between the source network device 102 and the destination network device 104 at step 506. In an exemplary embodiment, the method 500 also includes sending instructions to the destination network device 104 to initiate the assessment of the network devices 110 and 112.

The method 500 is terminated at step 514.

Various embodiments, as described above, provide a system and protocol for assessing one or more devices in a communication network, which has several advantages. One of the several advantages is a common protocol that can be used to assess the network devices using different network management software. Another advantage is that the a network administrator, who would otherwise spend significant amount of time compiling the assessment reports obtained from several tools can be enabled to assess heterogeneous network components from a single tool. Another advantage is that different software implementing this protocol for network assessment, will be able to share network-based intelligence with each other. Another advantage of the present invention is that with the availability of a unified protocol for network assessment, different software developers who may need network assessment functionality in their software will not need to build such functionality from the beginning, whereas, they can implement the unified protocol directly in their software.

Further, it should be noted that the invention should not be restricted with the applications and embodiments disclosed. Though exemplary embodiments have been presented in the foregoing detailed description of the invention, it should be appreciated that a vast number of variations exist. It should also be note that the disclosed embodiments and methods are not intended to limit the scope and applicability of the invention in any way.

Rather, the foregoing detailed description will provide those skilled in the art with a convenient road map for implementing an exemplary embodiment of the invention, it being understood that various changes may be made in the methods and order of steps described in an exemplary embodiment without departing from the scope of the invention as set forth in the appended claims and their legal equivalents.

1. A method for assessing one or more network devices in a communication network, the method comprising:
establishing a communication session with a source network device of said one or more network devices;
negotiating a payload format for exchange of information with said source network device;
receiving from said source network device, a first instruction identifying a set of parameters to be assessed, wherein said first instruction being in accordance with said negotiated payload format;
receiving from said source network device, a second instruction identifying a set of network devices to be assessed, wherein said second instruction being in accordance with said negotiated payload format;
assessing said set of parameters corresponding to said set of network devices; and
reporting an output of said assessment to said source network device, wherein said output being reported in accordance with said negotiated format.

2. The method as recited in claim 1 further comprising authenticating said source network device.

3. The method as recited in claim 1 further comprising receiving instructions to initiate said assessing.

4. The method as recited in claim 1 further comprising reporting interim results of said assessment prior to completion of said assessment.

5. The method as recited in claim 1 further comprising sending, to said source network device, information associated with termination of said session upon re-establishment of said session.

6. The method as recited in claim 1 further comprising continuing said assessing upon termination of said session.

7. The method as recited in claim 1, wherein said one or more network devices are selected from the group comprising a router, a gateway, a switch, a hub, a network bus, a modem, a cable and a computer.

8. The method as recited in claim 1, wherein said set of parameters are selected from the group comprising IP address, mac address, load information, bandwidth, security data, log table, topology, credentials, routing table, reachability status and trace-route information.

9. A method for assessing one or more network devices in a communication network, the method comprising:
establishing a communication session with a destination network device of said one or more network devices;
negotiating a payload format for exchange of information with said destination network device;
sending to said destination network device, a first instruction identifying a set of parameters to be assessed, wherein said first instruction being in accordance with said negotiated payload format;
sending to said destination network device, a second instruction identifying a set of network devices to be assessed, wherein said second instruction being in accordance with said negotiated payload format; and
receiving an output of said assessment from said destination network device, wherein said output being in accordance with said negotiated format.

10. The method as recited in claim 9 further comprising authenticating said destination network device.

11. The method as recited in claim 9 further comprising sending instructions to said destination network device to initiate assessing said set of network devices.

12. The method as recited in claim 9, wherein said one or more network devices are selected from the group comprising a router, a gateway, a switch, a hub, a network bus, a modem, a cable and a computer.

13. The method as recited in claim 9, wherein said set of parameters are selected from the group comprising IP address, mac address, load information, bandwidth, security data, log table, topology, credentials, routing table, reachability status and trace-route information.

14. A device for assessing one or more network devices in a communication network, the device comprising:
a transceiver capable of exchanging information with said one or more network devices;
a processor coupled to said transceiver; and
a non-transitory computer-readable storage medium coupled to said processor and said transceiver, wherein said processor executes one or more modules stored on said storage medium, said one or more modules comprising:
a session module configured to manage a communication session with a source network device of said one or more network devices;
a format negotiation module configured to negotiate a payload format with said source network device;
an instruction module configured to interpret instructions received by said transceiver from said source network device, said instructions comprising at least one of a first instruction identifying a set of parameters to be assessed and a second instruction identifying a set of network devices to be assessed;
an assessment module configured to assess said set of parameters associated with said set of network devices; and
a reporting module configured to generate an output of said assessment in accordance with said payload format and to invoke said transceiver to transmit at least said output to said source network device.

15. The device according to claim 14, wherein said non-transitory computer-readable storage medium further comprises an authentication module to authenticate said source network device.

16. The device according to claim 14, wherein said instruction module is further configured to interpret instructions to initiate said assessment.

17. The device according to claim 14, wherein said reporting module is further configured to generate interim results of said assessment prior to completion of said assessment.

18. The device according to claim 14, wherein said reporting module is further configured to generate information associated with termination of said session upon re-establishment of said session.

19. The device according to claim 14, wherein said assessment module is further configured continue said assessment upon termination of said session.

20. A device for assessing one or more network devices in a communication network, the device comprising:
a transceiver capable of exchanging information with said one or more network devices;
a processor coupled to said transceiver; and
a non-transitory computer-readable storage medium coupled to said processor and said transceiver, wherein said processor executes one or more modules stored on said storage medium, said one or more modules comprising:
a session module configured to manage a communication session with a destination network device of said one or more network devices;
a format negotiation module configured to negotiate a payload format with said destination network device; and
an instruction module configured to generate instructions for transmission by said transceiver to said destination network device, said instructions comprising at least one of a first instruction identifying a set of parameters to be assessed and a second instruction identifying a set of network devices to be assessed.
